(19) United States
(12) Patent Application Publication
(10) Pub. No.: US 2005/0071842 A1
(43) Pub. Date: Mar. 31, 2005

(54) Method and system for managing data using parallel processing in a clustered network

(75) Inventor: Arun K. Shastry, Westford, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: TotalETL, Inc., Westford, MA (US)

(21) Appl. No.: 10/910,948

(22) Filed: Aug. 4, 2004

Related U.S. Application Data
(60) Provisional application No. 60/492,413, filed on Aug. 4, 2003.

(51) Int. Cl. G06F 9/46

(52) U.S. Cl. 718/100

(57) ABSTRACT

An ETL/EAI data warehouse management system and method for processing data by dynamically distributing the computational load across a cluster network of distributed servers using a master node and multiple servant nodes, where each of the servant nodes owns all of its resources independently of the other nodes.

### RELATED APPLICATION

This application claims the benefit of U.S. Provisional Application No. 60/492,413, filed Aug. 4, 2003. The entire teachings of the above application are incorporated herein by reference.

### BACKGROUND OF THE INVENTION

Enterprises, whether large or small, produce and consume huge volumes of information during their regular operation. The sources for this information may be relational databases, files, XML, mainframes, web servers, and metadata-rich abstract sources such as Customer Relationship Management (CRM), Enterprise Resource Planning (ERP), and Business Intelligence (BI) systems. Enterprises demand that the heterogeneous information they produce be integrated and “warehoused” in a form that may be easily analyzed and accessed. With the global marketplace expanding constantly, many enterprises must maintain their systems 24 hours a day, seven days a week. Large enterprises, in particular, have a critical need to harness their vast corporate data. This puts pressure on processes that load the information warehouses to be as fast and as efficient as possible. These processes, which “Extract” data from many heterogeneous sources, “Transform” the data to desired formats, and “Load” them to target data warehouses, are collectively called ETL (Extract, Transform, Load) processes.

Tools that have been developed to perform this process are known as ETL solutions (also referred to herein as ETL tools). The majority of current ETL solutions grew out of the need of modem enterprises to fully integrate heterogeneous IT systems using disparate databases for e-business, CRM, ERP, BI, and other such enterprise activities. Successful e-business initiatives require fully functional ETL and BI components to leverage numerous databases, metadata repositories, web log files, and end-user applications. Typically, more than 50% of a data warehouse project time is spent on ETL design and development, which makes it the most critical component for any project's success. ETL and Enterprise Application Integration (EAI) tools are responsible for managing enterprise information as well as optimizing business intelligence and data integration environments. Hence, development and maintenance of such processes become key in the long-term success of the overall information warehouse systems.

Traditionally, many custom developed computer programs performed the ETL functions. More recently, however, pre-packaged software has become commonplace. The prepackaged ETL tools typically have Graphical User Interfaces (GUIs) to facilitate development. Today's prepackaged ETL tools can be categorized as either code generators or codeless engines.

Code generators automatically generate native code, scripts, and utilities needed to 1) extract data from one or more systems, 2) transform them, and 3) load them to one or more target systems. Code generators work well in environments where data is stored in flat files, and hierarchical databases and record-level access is fast. In most cases, such implementations are directed to the operating system of the platform on which the ETL process runs, and are limited in functionality and performance when a heterogeneous environment is introduced.

Codeless engines offer more functionality compared to code generators. Codeless engines are an ETL tool based on a proprietary engine that runs all of the transformation processes. However, because they typically require that all data flow through their engine, the engine itself can become a performance bottleneck for high-volume environments. Most prepackaged codeless ETL tools in the market today are monolithic in nature and suffer from the performance issues mentioned above.

### SUMMARY OF THE INVENTION

Large enterprises continue to struggle with transforming operational data into a useful asset for business intelligence. In an effort to cut costs, many large enterprises approach the data integration by writing significant amounts of code or attempting to leverage tools that may not quite fit the problem but are perceived to be “free” because the enterprise owns them. Some enterprises also reduce IT staff in an attempt to cut costs. As enterprises reduce IT staff, they seek new ways to deliver data warehouse projects in a more time-effective manner, and ETL tools meet this need.

The present invention provides a component based ETL tool for managing data through parallel processing using a clustered network architecture. An embodiment of the present invention takes advantage of the advent of component methodology, such as Sun's Enterprise JavaBeans (EJB) and Microsoft's NET, which enables the ETL tool of the present invention to scale with an enterprise's ongoing demand for performance. In addition to satisfying the performance criteria of speed and efficiency, the present invention introduces a flexible ETL process that easily adapts to incorporate changes in business requirements.

As businesses grow in size and increase their data volumes, load patterns changes gradually both in volume and complexity. In addition to these, in many cases the businesses have to change the loads because the nature of their business changes with time. These changes are mostly changes in requirements or changes in specifications. For example, a company may need to add a new data source to an existing job when if it acquires another company. The invention provides open-ended scalability by using a cluster of processing computers and allowing any number of heterogeneous processing computers (interchangeably referred to herein as “nodes” or “servers”) to be added within a given infrastructure. The invention adopts a share-nothing approach with regard to resources such as CPUs, memory, and storage. Each server “owns” all of its resources independently of other nodes in the system. In addition, there are no restrictions imposed on the types of hardware to be used, so the nodes can be 100% heterogeneous.

An embodiment of the present invention processes large volumes of data by dynamically distributing the load across a group of heterogeneously networked processing nodes. Within the cluster, one node is designated a “master” node that manages the ETL processing through the cluster, with the remaining nodes designated “servant” nodes for processing. The master node receives jobs, separates the job into a number of job steps, assigns each of the job steps to a particular servant node, stores the schedule of assigned job steps in a repository, and sends the assigned job steps to servant nodes based on the schedule of assigned jobs. The servant nodes receive job steps from the master node, communicate with the repository to determine availability of data, extract data from a data source, process the job step on the extracted data, and notify the repository when the job step has been processed.

The data source may be an external source memory or a cached memory from another node in the cluster. This allows the master node to determine data dependencies among the job steps, and assign the job steps accordingly. If there is no dependency among particular job steps, i.e. they are mutually data independent of each other, they can be performed in parallel among different nodes; if there is a dependency, a node can periodically check the schedule to determine if the dependent data is available for processing, and then obtain the data from the cached memory of the appropriate node. By distributing the processing in this manner, and allowing each node to extract and process the data it requires for its job step, the present invention avoids bottlenecks and network congestion, thus reducing overall IT infrastructure costs for an enterprise.

In addition, an increase in data volume can be automatically handled by the cluster by increasing the level of parallelism for a specific job. The cluster can try to re-use a node that has been used in the earlier job steps for future steps. In one embodiment of the present invention, if such a reconfiguration is not possible, the system will alert the administrator regarding the potential of missing Service Level Agreements for that job.

If requirements change for existing jobs, the user can make changes to the job. The cluster can analyze the new job and optimize it, keeping in consideration the prior optimization path. Any affinities or special considerations utilized earlier in the job will be attempted to be saved, if it makes sense; otherwise the cluster will discard the old optimization path and create a brand new plan for the job.

Businesses are accustomed to constant changes in their infrastructures, some of which may be small while some may be drastic. The cluster can be configured to be immune to most of such changes and adapt to the new environments. For example, if the business makes a strategic shift from one operating system to another, such as Microsoft Windows to Unix, the entire cluster configuration can be incrementally migrated to the new infrastructure without losing the current jobs and schedules. As and when a node is reconfigured on the new hardware platform, the cluster can update its configuration data in a repository. This type of a change is more drastic than others such as migration from one relational database to another; in which case the change in the configuration is rather small to none.

A particular embodiment of the present invention operates on any J2EE-compliant application server such as BEA WebLogic or IBM WebSphere and is accessible to end users via a web-based Graphical User Interface (GUI). To enable rapid installation and use, the particular embodiment includes an OEM version of BEA WebLogic server. A particular embodiment of the present invention is coded with Sun's Enterprise JavaBeans (EJB) component-based technology.

The present invention also takes advantage of the clustered architecture in maintaining functionality in the event any of the nodes fail. Using a periodic signal or ping, the master node notifies each node in the system of its current activity, and requests a return signal. If the servant node fails to receive a signal from the master within a certain period, the system allows for the transfer of “master node” duties to a servant node. Should the master node fail to receive a return signal from a particular servant node, the master node can update the schedule to remove the inactive servant node from the list of possible nodes to assign job steps.

### BRIEF DESCRIPTION OF THE DRAWINGS

The foregoing and other objects, features and advantages of the invention will be apparent from the following more particular description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a high level technical architecture diagram that includes the system of the present invention.

FIG. 2 is a detailed diagram of the technical architecture of FIG. 1.

FIG. 3A is diagram of the elements of a slave node used in system of the present invention.

FIG. 3B is diagram of the elements of the master node used in system of the present invention.

FIG. 4 illustrates a sample data transformation job as performed by the system of the present invention.

FIG. 5 is a program flow diagram of the present invention for master node process management.

FIG. 6 is a program flow diagram of the present invention for slave node process management.

FIG. 7 is a program flow diagram of the present invention for fail-over process control by master node.

### DETAILED DESCRIPTION OF THE INVENTION

A description of particular embodiments of the invention follows.

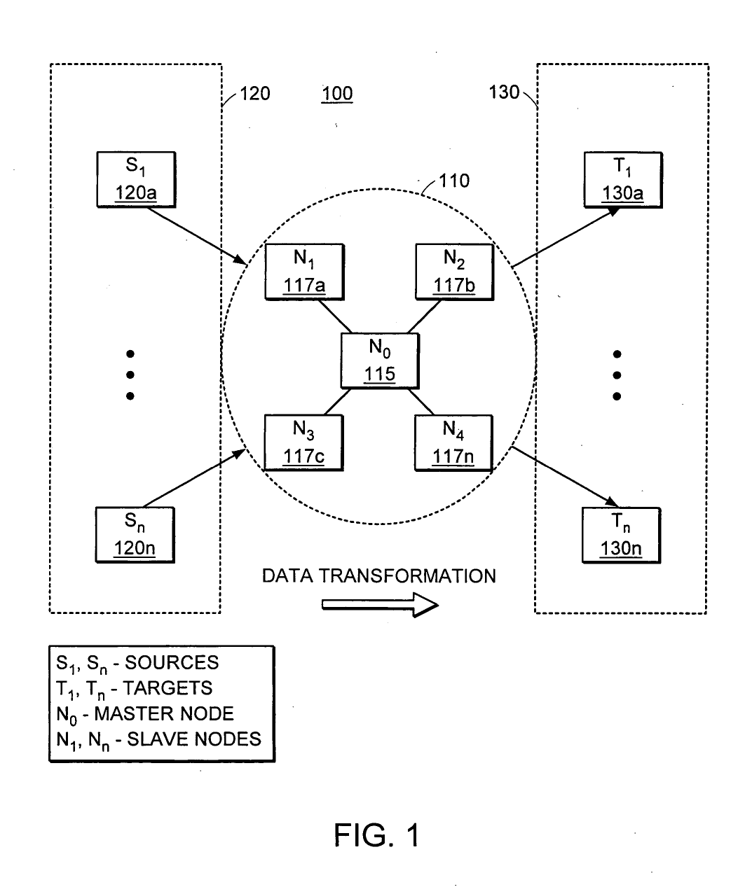

FIG. 1 illustrates a representative network architecture 100 that includes the cluster 110 of processing computers 115, 117a ^{. . .} n of the present invention. The cluster 110 operates as a intermediary between a data source 120 and a data target warehouse 130. The various data sources 120a ^{. . .} n may be heterogeneous sources such as relational databases, spreadsheets, text files, XML files, mainframes, web servers, and metadata-rich abstract sources such as Customer Relationship Management (CRM), Enterprise Resource Planning (ERP), and Business Intelligence (BI) systems. The data target warehouse may comprise a single 130 or a plurality 130a ^{. . .} n of data storage devices or media. The data targets may also be heterogeneous targets such as relational databases, spreadsheets, text files, XML files, mainframes, web servers, CRM systems, ERP systems, and BI systems. The processing cluster 110 can comprise a homogeneous or heterogeneous group of processing computers or nodes 115, 117a ^{. . .} n. Within the cluster in FIG. 1, a single node is designated the “master node” 115 and the others are designated “servant” nodes 117a ^{. . .} n.

The master node 115 is responsible for receiving jobs and separating them into discrete job steps. It then manages the processing of job steps within the cluster by scheduling the job steps to the servant nodes 117a ^{. . .} n and monitoring servant nodes activities. Each node may have the capability of serving as either a master or servant node, and depending on the network activity or processing capabilities, the designation of “master” capabilities may dynamically change. There may be situations where more than one node is designated as a “master” to manage certain nodes within the cluster. While the master node manages the processing, it may also serve as a processing node and be assigned job steps as any servant node might. Further, the number of nodes in the cluster may be scalable to suit the data processing needs of the enterprise and can be easily added to the clustered network 110 without disruption.

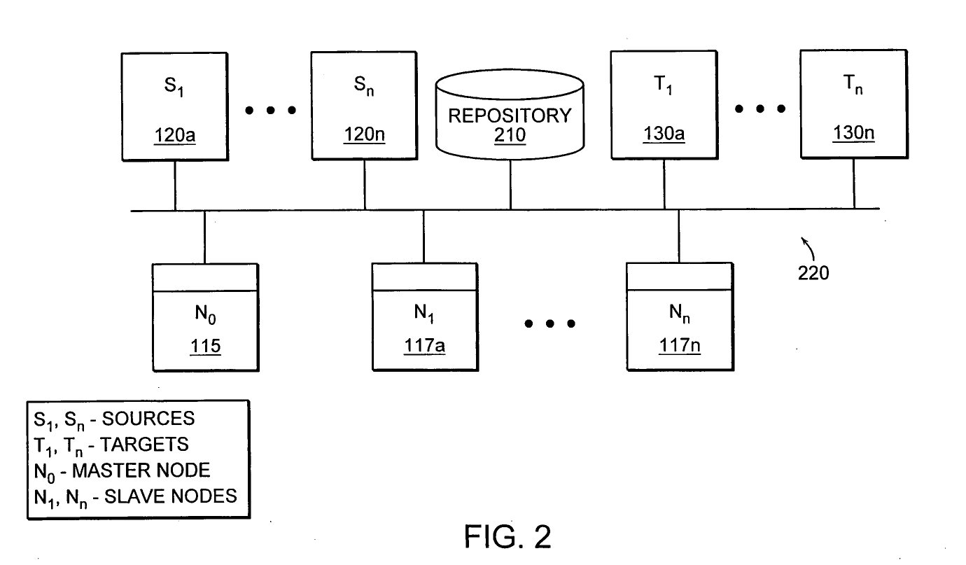

FIG. 2 shows a more detailed view of an embodiment of the architecture of FIG. 1. The network architecture of the embodiment involves a single bus 220 in a network topology where each device is in direct communication with each other and all signals pass through each of the devices. Each device has a unique identity and can recognize those signals intended for it. This enables each processing node 115, 117a ^{. . .} n to extract data from each of the various data sources 120a ^{. . .} n, communicate with and provide data to other processing nodes, and load data into any data target 130a ^{. . .} n.

The system of FIG. 2 also includes a repository 210 which contains the job schedule as determined by the master node 115, and may also contain information relating to the processing statistics of the various servant nodes. Each servant node may then access the job schedule from the repository 210 to determine where it needs to extract data, and/or whether that data is currently available.

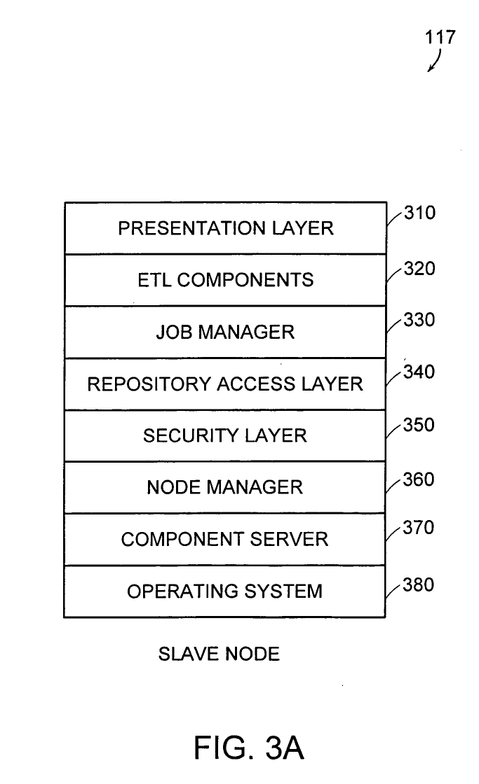

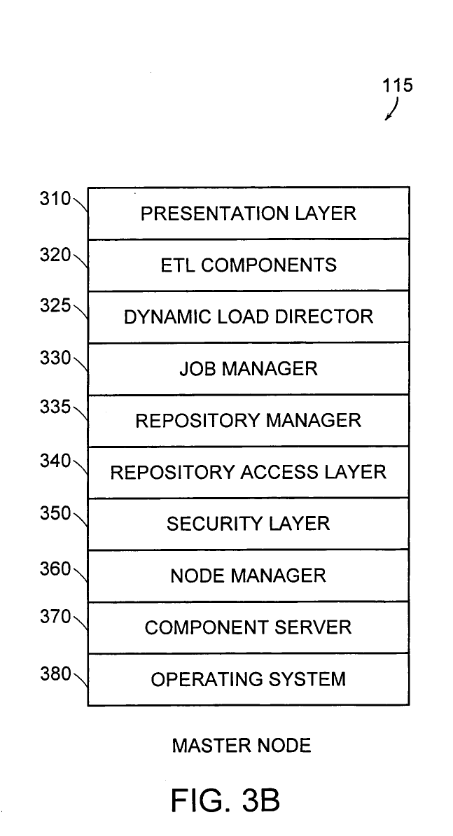

FIGS. 3A and 3B represent the operating elements of embodiments of a servant node 117 and master node 115 respectively. Both nodes include a presentation layer 310 that serves as a graphical user interface; an ETL Components layer 320 that serves as a container for the various ETL components; a Job Manager 330 that manages all job steps assigned to a particular node and updates the status of such job steps in the Repository; a Repository Access Layer 340 that manages all transactions between the Repository; a Security Layer 350 that controls access privileges for job steps assigned to the node based on a number of factors including, for example, the user who is running the job step, resources on the node, remote resources being accessed by the node; a Node Manager 360 that monitors all activities on the node, captures resource consumption metrics (for example, CPU, memory, I/O, network and other such metrics), regularly updates these metrics in the Repository, and also responds to the master node's ping requests; a Component Server 370 that acts as a container for all operators and provides a suite of services including messaging, transaction management, resource pooling, context switching, and a universal layer of abstraction from the underlying operating system/platform and an Operating System 380 that organizes and controls the hardware of the particular node.

The master node 115 includes added functional capabilities such as the Dynamic Load Director 325 that manages and balances the job step loads of all the nodes within the cluster; and the Repository Manager 335 that creates and maintains the metadata for the entire cluster, including node configuration data, user data, security information, dataflows, source and target specific information, jobs and schedules in the Repository

The Component Server 370 typically is an EJB container, such as IBM WebSphere, or a Microsoft NET platform. Operators are divided up into four main types: Connectors, Extractors, Transformers and Loaders. Connectors allow the nodes to connect to a data source, such as, relational databases, spreadsheets, text files, XML files, mainframes, web servers, CRM systems, ERP systems, and BI systems. The system of the present invention creates a default number of connectors on each node to various data sources or data targets, and may either add or disconnect connectors depending on node activity. Extractors use the metadata from Connectors, and extract data from the corresponding data source. As the data is extracted, Extractors organize the information into special relational fields. Transformers perform the bulk of the data transformation and operate at two levels: (1) Record Level Transformers perform operations on whole records of data and are exemplified by commands such as “SORT,” “JOIN” or “FILTER”; (2) Attribute Level Transformers perform operations within a record, and may include commands such as “CONCATENATE” or “INCREMENT.” Loaders load data to data target destinations such as relational databases, spreadsheets, text files, XML files, mainframes, web servers, CRM systems, ERP systems, and BI systems. These employ the use of Connectors to connect to a data target to point to a particular object therein.

Apart from issues of data dependency, the master node may assign job steps to nodes using any general scheduling technique such as a round robin, or a Least Recently Used (LRU) algorithm. The mast node may also provide for affinity assignments to take advantage of particular servant nodes with specialized processing capabilities. For example, a servant node with a large amount of physical memory may be assigned to memory intensive Transformers such as Sort or Join. The master node also recognizes certain job steps are dependent on data processed in other job steps, and can schedule the performance on the data dependent job step accordingly using markers in a job schedule contained in the repository 210.

When a node is added or removed from the cluster, the entire cluster automatically reconfigures itself to the change. The new node is immediately pulled into the system and existing jobs are parsed to take advantage of the new node. If a node is removed, intentionally or not, it is marked as not available for jobs and any job steps that were assigned to that node will be reconfigured and re-assigned to other available node(s).

Whenever a node is reconfigured, either at the hardware or at the software level, the cluster “reads” the new configuration and makes appropriate changes in the repository. For example, if a node gets a memory or a CPU upgrade, the existing jobs will be parsed to take advantage of the added capacity of the node.

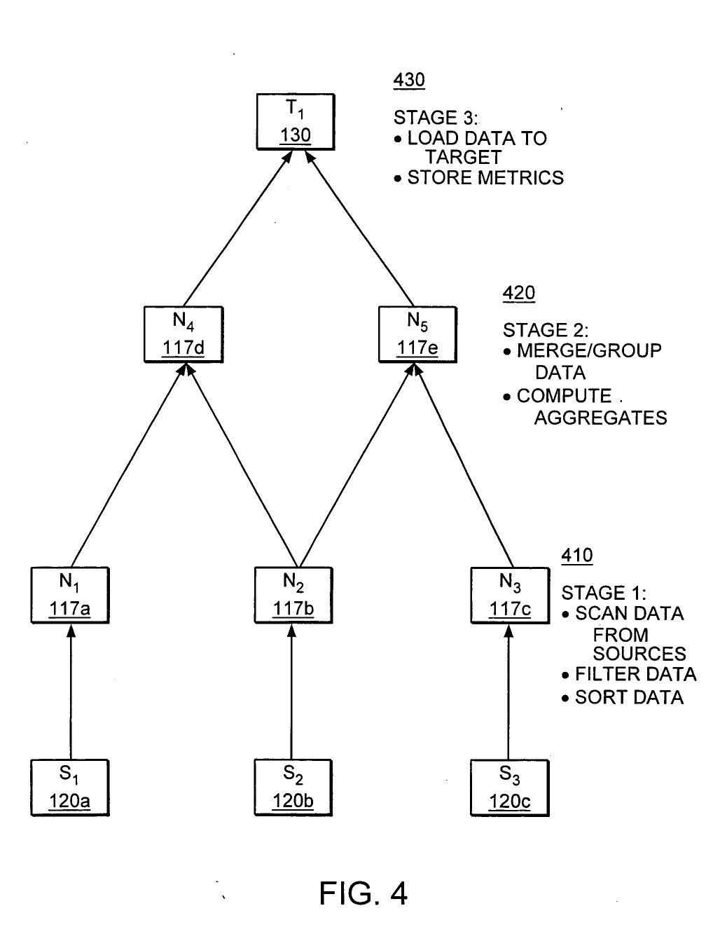

FIG. 4 shows the flow of a sample job step assignment through a cluster of processing computers in an embodiment of the present invention. A single job is broken down by the master node into 5 separate job steps. At first stage 410, three of the job steps can be immediately performed in parallel at three separate nodes 117a-c. In this particular example, these nodes extract data from three separate data sources 120a-c respectively. However, the nodes may extract data from the same data source. The three nodes process their assigned job steps and report back to the master and repository indicating the completion of their respective job steps.

At the second stage 420, two other nodes 117d-e have been assigned job steps that are dependent on the data produced in the three first stage nodes 117a-c. In this particular example, one second stage node 117d requests data stored in the buffers of two of the first stage nodes 117a-b, while the other second stage node 117e also requests data stored in the buffers of two of the first stage nodes 117b-c. In both second stage nodes, data is requested and obtained from a common node 117b. Once the two second stage nodes receive the data, they can perform their respective job steps and load the data into a data target 130a.

At the third stage 430, the data target 130 receives the data from the two nodes 117d, 177e to complete the particular job. In addition, job metrics, such as processing time, memory access time, and other performance metrics can be stored for future reference.

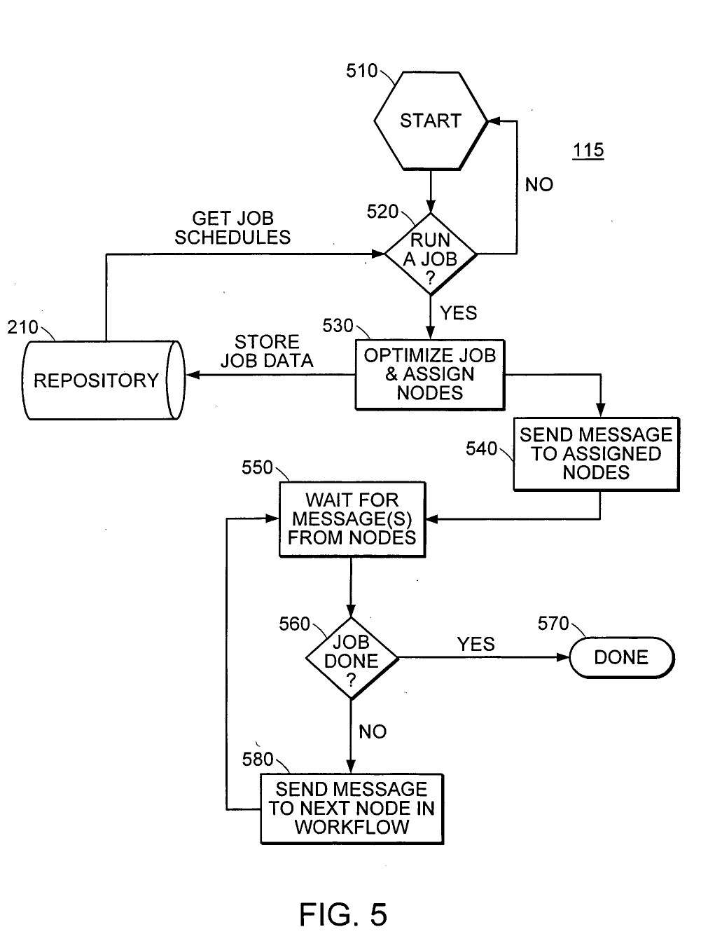

FIG. 5 illustrates the program flow for master node process management. In the Master Node 115, a “Start” 510 status is followed by a “Run Job” 520 test. The “Run Job” 520 test periodically polls a Repository 210 database for job schedules. If the “Run Job” 520 returns “no,” the program returns to the Start 510 status. If the “Run Job” 520 returns “yes,” an “Optimize Job And Assign Nodes” 530 process starts, wherein the processing job is assigned as one or more jobs/steps to one or more Slave Nodes and job data is stored in the Repository 210 database. After the “Optimize Job And Assign Nodes” 530 process completes, a “Send Message To Assigned Nodes” 540 process starts, wherein the Jobs/Steps are sent to the Slave Nodes. After the “Send Message To Assigned Nodes” 540 process completes, a “Wait For Message(s) From Nodes” 550 process starts and is followed by a “Job Done” 560 test. If the “Job Done” 560 test returns “yes,” the Master Node 115 returns a “Done” 570 status. If the “Job Done” 560 test returns “no,” the “Send Message To Next Node In Workflow” 580 process runs and then the “Wait For Message(s) From Nodes” 550 process starts as described above.

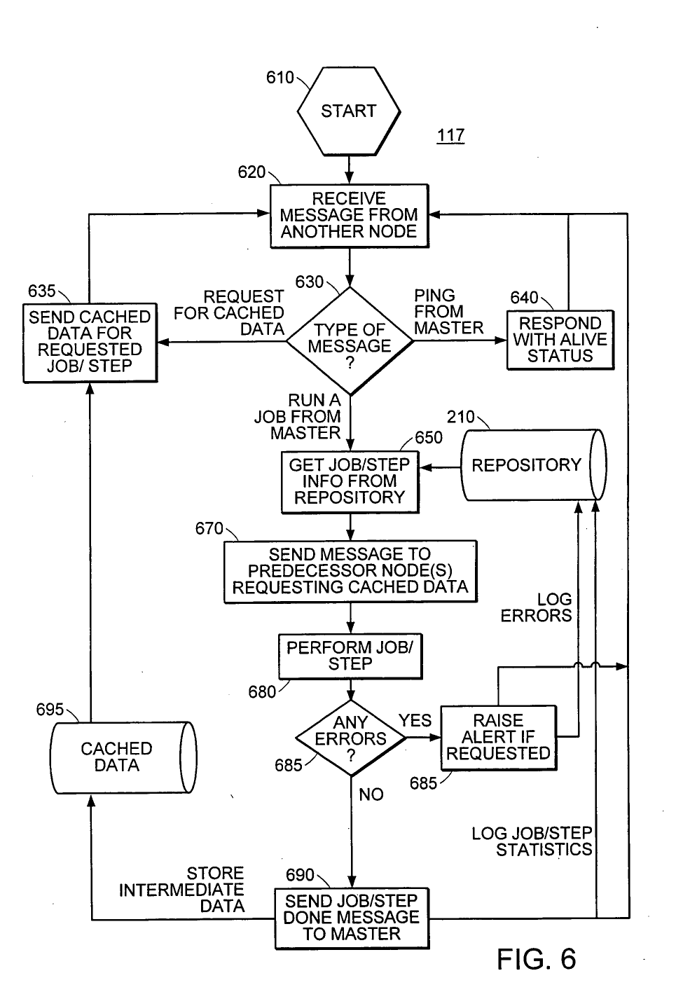

FIG. 6 illustrates the program flow for slave node process management. In a Slave Node 117, a “Start” 610 status is followed by a “Receive Message From Another Node” 620 process, which spawns a “Type Of Message” 630 test. If the “Type Of Message” 630 test indicates that the message is a “request for cached data,” a “Send Cached Data For Requested Job Step” 635 process runs and then returns to the “Receive Message From Another Node Job” 620 process. If the “Type Of Message” 630 test returns “ping from master,” a “Respond With Alive Status” 640 process runs and then returns to the “Receive Message From Another Node” 620 process. If the “Type Of Message” 630 test returns “run a job from master,” then a “Get Job/Step Info From Repository” 650 process starts, followed by a “Send Message To Predecessor Node(s) Requesting Cached Data” 670 process, a “Perform Job/Step” 680 process, and an “Any Errors” 685 test. If the “Any Errors” 685 test returns “yes,” a “Raise Alert If Requested” 686 process runs and then returns to the “Receive Message From Another Node” 620 process. If the “If the Any Errors” 685 test returns “no,” a “Send Job/Step Done Message To Master” 690 process runs, and then 1) Intermediate Data is stored in a Cached Data 695 database and the “Send Cached Data For Requested Job Step” 635 runs as describe above; 2) Job/Step Statistics are stored in the Repository 210 database and the “Get Job/Step Info From Repository” 650 process runs as described above; and 3) the “Receive Message From Another Node” 620 process runs.

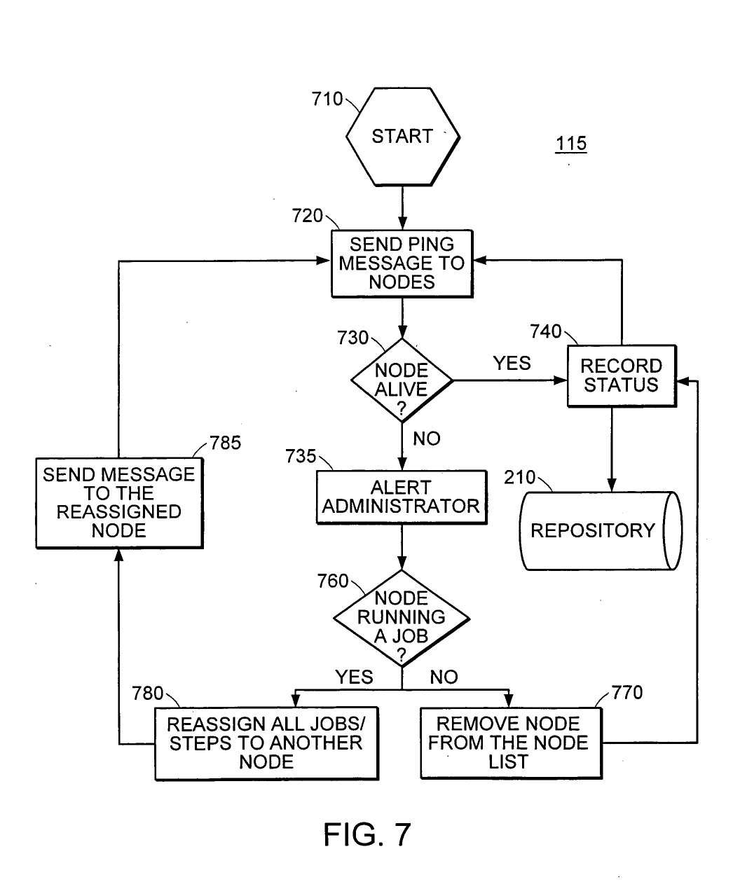

FIG. 7 illustrates the program flow for fail-over process control by the master node. In the Master Node 115, a “Start” 710 status is followed by a “Send Ping Message to Nodes” 720 process, which is followed by a “Node Alive” 730 test. If the “Node Alive” 730 test returns “yes,” a “Record Status” 740 process starts and status is stored in a Repository 210. If the “Node Alive” 730 test returns “no,” an “Alert Administrator” 735 process runs followed by a “Node Running A Job” 760 test. If the “Node Running A Job” 760 test returns “no,” a “Remove Node From The Node List” 770 process runs, followed by the “Record Status” 740 process as described above. If the “Node Running A Job” 760 test returns “yes,” a “Reassign All Jobs/Steps To Another Node” 780 process runs, followed by a “Send Message To The Reassigned Node” 785 process, followed by the “Send Ping Message To Nodes” 720 test as described above.

In another embodiment, the present invention can be adapted on a smaller scale to perform on a network of personal computers (such as a laptop computer or a desktop computer) linked as a mini-cluster through a USB, Ethernet, or other network connection. The system can operate on any supported data source, including relational databases, desktop applications such as Microsoft Office and OpenOffice.org files, spreadsheets, and the like, using the shared processing ability of the multiple personal computers to process data in a more efficient manner. Similar to what has been described above, a single computer serves as a “master node”, breaks down jobs into job steps, and assigns the job steps to any number of the computers connected to the cluster. The desktop operation of the system allows users to simply link their computer with any available computers to create the clustered network for managed parallel processing.

Other features of a particular embodiment of the present invention include a dashboard application that enables senior management to rapidly obtain Key Performance Indicators/Metrics (KPI/KPM) in their organizations in an easily readable graphical format. This provides for two different interfaces to view the performance of the system, and allows for communication between a non-technical senior manage and IT staff. The non-technical senior manager is able to quickly identify relevant information and easily communicate to IT staff any necessary changes to the data transformation and storage process in order to make the information more accessible and useful. To that same end, a particular embodiment may also include specific ETL functions to expedite data warehouse development. Other embodiments include adapters for interconnecting to and with CRM/ERP systems such as Siebel and SAP; and real-time messaging and support for third-party messaging applications such as TIBCo and MSMQ.

Those of ordinary skill in the art should recognize that methods involved in a method and system for managing data using parallel processing in a clustered network may be embodied in a computer program product that includes a computer usable medium. For example, such a computer usable medium can include a readable memory device, such as a solid state memory device, a hard drive device, a CD-ROM, a DVD-ROM, or a computer diskette, having stored computer-readable program code segments. The computer readable medium can also include a communications or transmission medium, such as a bus or a communications link, either optical, wired, or wireless, carrying program code segments as digital or analog data signals.

While this invention has been particularly shown and described with references to particular embodiments thereof, it will be understood by those skilled in the art that various changes in form and details may be made therein without departing from the scope of the invention encompassed by the appended claims.

1. A method for managing data comprising:
receiving a job at a master processing node of a cluster of computer processing nodes;
separating the job into a plurality of job steps;
assigning each of the job steps to a particular servant node of the cluster of computer processing nodes;
maintaining a schedule of assigned job steps in a repository that provides information related to job step completion and availability of data at servant nodes;
sending job steps to the individual servant nodes based on the schedule of assigned job steps;
extracting data from at least one data source;
processing job steps on extracted data at servant nodes; and
storing data from the processed job steps into a target destination.

2. A method of claim 1 wherein assigning the job steps comprises:
(i) identifying jobs steps that are dependent on processed data from other job steps as dependent job steps;
(ii) assigning independent job steps to servant nodes for parallel processing; and
(iii) assigning dependent job steps to other servant nodes for processing after data is available from other job steps.

3. A method of claim 2 wherein the data source can be either an external source memory or a cached memory from a node in the cluster of computer processing nodes.

4. A method of claim 3 further comprising sending processed data from a servant node's cached memory to other servant nodes for use in subsequent job steps.

5. A method of claim 2 wherein the target destination can be either an external target destination or a cached memory of the servant node in the cluster of computer processing nodes.

6. A method of claim 1 wherein the master node periodically polls the secondary nodes to determine the secondary nodes' availability for processing.

7. A method of claim 6 wherein the master node updates the schedule of assigned jobs based on changes in availability of servant nodes.

8. A method of claim 6 wherein a servant node acts as a master node if a predetermined period of time passes without any servant node receiving a periodic poll from the master node.

9. A method of claim 1 wherein nodes, data sources, target destination, and the repository communicate through the use of Enterprise Java Beans.

10. A method for managing data comprising:
receiving a job at a master processing node of a cluster of computer processing nodes;
separating the job into a plurality of job steps;
identifying jobs steps that are dependent on processed data from other job steps as dependent job steps;
assigning independent job steps to servant nodes for parallel processing;
assigning dependent job steps to other servant nodes for processing after data is available from other job steps;
maintaining a schedule of assigned job steps in a repository that provides information related to job step completion and availability of data at servant nodes;
sending job steps to the individual servant nodes based on the schedule of assigned job steps;
extracting data from at least one data source, wherein the data source can be either an external source memory or a cached memory from a node in the cluster of computer processing nodes;
processing job steps on extracted data at servant nodes; and
storing data from the processed job steps into a target destination.

11. A cluster of computer processing nodes for managing data comprising:
a repository that stores a schedule that provides information related to job step completion and availability of data at the processing nodes;
a master node and at least one servant node, each node in communication with the other nodes in the cluster, where:
(1) the master node (a) receives a job, (b) separates the job into a plurality of job steps, (c) assigns each of the job steps to a particular servant node, (d) stores a schedule of assigned job steps in the repository, and (e) sends the assigned job steps to servant nodes based on the schedule of assigned jobs; and
(2) a servant node (a) receives a job step from the master node, (b) communicates with the repository to determine availability of data, (c) extracts data from a data source, (d) processes the job step on the extracted data, and (e) notifies the repository when the job step has been processed.

12. A cluster of computer processing nodes of claim 11 wherein the master node further:
(i) identifies jobs steps that are dependent on processed data from other job steps as dependent job steps;
(ii) assigns independent job steps to servant nodes for parallel processing; and
(iii) assigns dependent job steps to other servant nodes for processing after data is available from other job steps.

13. A cluster of computer processing nodes of claim 12 wherein the servant node further stores data from the processed job step in either its own cached memory or an external target destination.

14. A cluster of computer processing nodes of claim 12 wherein the data source is either an external source memory or a cached memory from a node in the cluster of computer processing nodes.

15. A cluster of computer processing nodes of claim 12 wherein the servant node further sends data from its own cached memory to another node in the cluster of computer processing nodes.

16. A cluster of computer processing nodes of claim 11 wherein the master node periodically polls the secondary nodes to determine the secondary nodes' availability for processing.

17. A cluster of computer processing nodes of claim 16 wherein the master node updates the schedule of assigned jobs based on changes in availability of servant nodes.

18. A cluster of computer processing nodes of claim 16 wherein a servant node can act as a master node if a predetermined period of time passes without any servant node receiving a periodic poll from the master node.

19. A cluster of computer processing nodes of claim 11 wherein nodes, data sources, target destination, and the repository communicate through the use of Enterprise Java Beans.

20. A computer-readable medium having stored thereon sequences of
instructions, the sequences of instructions including instructions, when
executed by a processor, causes the processor to perform:
receiving a job at a master processing node of a cluster of computer processing nodes;
separating the job into a plurality of job steps;
assigning each of the job steps to a particular servant node of the cluster of computer processing nodes by:
(i) identifying job steps that are dependent on processed data from other job steps as dependent job step;
(ii) assigning independent job steps to servant nodes for parallel processing; and
(iii) assigning dependent job steps to other servant nodes for processing after data is available from other job steps;
maintaining a schedule of assigned job steps in a repository;
sending job steps to the individual servant nodes based on the schedule of assigned job steps;
extracting data from at least one data source;
processing job steps on extracted data at servant nodes; and
storing data from the processed job steps into a target destination.
